(19) United States
(12) Patent Application Publication
(10) Pub. No.: US 2014/0161929 A1
(43) Pub. Date: Jun. 12, 2014

(54) COMPOSITION WITH A YOGURT-LIKE TEXTURE

(71) Applicants: Christoph Briegleb, Wuerzburg (DE); Elini Chiotelli, Paris (FR); Evelyn Krämer, Ochsenfurt (DE); Arnaud Lyothier, Colombes (FR)

(72) Inventors: Christoph Briegleb, Wuerzburg (DE); Elini Chiotelli, Paris (FR); Evelyn Krämer, Ochsenfurt (DE); Arnaud Lyothier, Colombes (FR)

(73) Assignees: DONONE GMBH, Haar (DE); COMPAGNIE GERVAIS DANONE, Paris (FR)

(21) Appl. No.: 14/131,136

(22) PCT Filed: Jul. 4, 2012
(86) PCT No.: PCT/EP2012/063050

§ 371 Date: Jan. 6, 2014

(30) Foreign Application Priority Data
Jul. 7, 2011 (IB) PCT/IB2011/001862

(51) Int. Cl. A23L 1/05

(52) U.S. Cl. CPC A23L 1/05
USPC 426/2; 426/573; 426/575; 426/577; 426/578

(57) ABSTRACT

The invention concerns a composition that can substitute yogurts. The composition comprises water, a rice concentrate, a cereal flour, a vegetal protein source, and a thickening agent.

The invention concerns a composition that can substitute yogurts.

Yogurts are products obtained by fermentation of animal milk by lactic acid bacteria. Yogurts constitute a good nutrition source. Fermentation produces lactic acid that lowers the pH and causes the milk proteins to precipitate and set. Yogurts are a good source of proteins and calcium, with a balanced fat and carbohydrate content. Meanwhile yogurts are appreciated products providing some indulgence to the consumer, due to their organoleptic properties, including taste, rheological properties such as viscosity, and mouthfeel properties, including for example stickiness and/or gluey behavior.

As far as rheological properties are concerned, there are two main forms of yogurts: set yogurts and stirred yogurts. Set yogurts are non fluid products obtained after precipitation of the milk proteins. Stirred yogurts are fluid products obtained by stirring set products. They typically have a texture that is different from a gel, typically non gluey and/or non sticky and/or non slimy. The viscosity of stirred yogurts can be tuned by adapting the stirring and optionally by adding thickening agents. Products with significant viscosity can be handled practically with a spoon and are referred to as spoonable products. Stirred spoonable products are especially appreciated.

However some people do not tolerate milk-based yogurts, for example because of lactose intolerance, milk protein intolerance and/or allergies. To address this, soy-based yogurts have been developed. However their texture is slightly different from yogurts and the taste is also different. Moreover a part of soy cultures are Genetically Modified Organisms (GMOs) cultures and some people reject products with GMOs. Some people do not trust tracking indication and consider that there is a risk that any soy-based product be contaminated by GMOs even if the label provides the contrary. Thus there is a need for other products.

Document WO 2009/101521 describes food compositions comprising vegetable milk such as soy milk, rice milk or almond milk, and powdered cereals such as barley, oat or rice, a pea extract such as pea protein, and other ingredients. The compositions are provided in a powdered form to be mixed with hot or cold water, for example at a ratio of 1 part of composition to 5 parts of water, to provide a drink. Such mixtures have a very low viscosity and do not provide substitutes to yogurts.

Document US 2010/0189864 describes “extensible” food compositions comprising various flours, vegetal protein sources such as pea proteins, and up to 44% water in the examples. The compositions are solid or pasty and can typically be shaped. They are then typically processed to form finished food products. The compositions do not comprise rice extract and do not provide substitutes to yogurts.

Document EP 1198991 describes mixtures of rice extracts that are useful to prepare non-dairy products such as milk substitutes and crème dessert. The compositions do not comprise proteins other than rice proteins, and do not comprise oat flour. Such compositions do not present a taste and/or a texture that gives much satisfaction to consumer, as they typically have a slimy and transparent texture, with low creaminess. Accordingly the compositions are not adapted as substitutes to yogurts.

Document WO 98/31240 describes texturing agents adapted for fat replacement, based on starch flours such as rice flour or oat flour, and on proteins such as milk proteins, soy proteins or pea proteins. The compositions do not comprise a mixture of oat flour and rice flour. The texturing agents are processed with water by heating, for example by steam injection. They can provide textured food compositions. However such agents provide compositions that do not present a taste and/or a texture that gives much satisfaction to the consumer, as they typically have a slimy and transparent texture, with low creaminess.

Document WO 97/26799 describes frozen syrup compositions comprising oat flour and rice flour, free of exogenous stabilizers and proteins. Such compositions are not adapted as substitutes to yogurts.

Document US 5753295 describes beverage compositions comprising soy milk or rice milk and fibers such as guar gum. The compositions have a low viscosity and are not adapted as substitutes to yogurts.

Some milk-free and/or soy-free products are available on the market. However these present gels textures with significant stickiness and/or with a significant gluey behavior. These are not satisfying as a yogurt substitutes. There is thus a need for compositions that are closer to yogurt textures, with no or lower gel textures and/or with no or low stickiness and/or with no or low gluey behavior. There is still a need for such compositions that would further present a good aspect and a good taste.

Thus there is a need for products that can be substantially milk-free and soy-free, and that still present the advantages of yogurts, especially a good nutrition source, and rheological properties that are close to those of yogurts, typically with no stickiness.

The invention addresses at least one of the needs and/or problems mentioned above by providing a composition comprising:

a) at least 50% by weight of water,
b) at least one rice concentrate comprising rice flour,
c) a cereal flour selected from the group consisting of oat flour, spelt flour, barley flour and mixtures thereof,
d) at least one vegetal protein source, further to the rice concentrate and the cereal flour,
e) optionally a calcium source,
f) optionally organoleptic modifiers,
g) a thickening agent, further to the rice flour and the cereal flour,
wherein the relative amount by weight of rice flour compared to the total amount of rice flour and cereal flour is of from 5% to 95%, preferably from 7% to 93%, preferably from 25% to 75%, and the total amount of rice flour and cereal flour is of at least 4% by weight, and
wherein the composition has, per 100 g of composition:
a protein content of at least 1 g,
a fat content of from 0.1 g to 10 g, preferably of from 0.5 g to 4 g,
a carbohydrate content of from 5 g to 45 g, preferably of from 8 g to 20 g.

It has been found that the combination of the rice concentrate with the cereal flour allows avoiding stickiness and/or gels textures, while having a satisfying taste. It has been found that such properties are especially enhanced when one uses a high shear process to prepare the composition.

### DEFINITIONS

In the present specification the term “cereal” is used for cereals different from rice. The term cereal is used to designate oat, spelt, barley and mixtures thereof.

In the present specification the viscosity of a composition refers to the viscosity measured at 10° C. at a shear of 64 s⁻¹, typically measured with a Rheomat device, using tube 2, bob 2, with one point of measurement at 10 s. It is noted that the viscosity can be typically of from 500 to 4000 mPa·s.

In the present application a “non gel” composition is defined as a composition having:

a gel parameter of lower than or equal to 50 g, preferably lower than or equal to 45 g, preferably lower than or equal to 35 g, said gel parameter being defined as the value measured with TAXT-2 apparatus at a temperature of 10° C. with a cylinder of 25 mm, a penetration distance of 20 mm, a plunger speed of 0.2 mm/s, and a preload value of 0.5 g, and/or

no or slight stickiness, and/or

no or slight gluey behavior.

In the present application a “milk-free” composition refers to a composition having the following features:

less than 0.1% by weight of milk, preferably substantially 0%, and/or

less than 0.1% by weight of lactose, preferably substantially 0%, and/or

less than 0.1% by weight of milk protein, preferably substantially 0%, and/or

less than 0.1% by weight of casein, preferably substantially 0%.

In the present application a “soy-free” composition refers to a composition having the following feature:

less than 0.1% by weight of soy or soy extracts, preferably substantially 0%.

### Composition of the Invention

The composition comprises several ingredients that are detailed below. As a nutritional profile, the composition has, per 100 g of composition:
a protein content of at least 1 g,
a fat content of from 0.1 g to 10 g, preferably from 0.5 g to 4 g,
a carbohydrate content of from 5 g to 45 g, preferably from 8 g to 20 g.

The ingredients and the amounts thereof can be selected to have this nutritional profile. The one skilled in the art knows how to determine the nutritional profile (energy, proteins, fat, carbohydrate, and/or added sugars) of compositions. It can be calculated from tables relevant to the various ingredients. It can alternatively be measured from the compositions by techniques known by the one skilled in the art.

In one embodiment the composition is substantially free of milk, typically of animal milk. In one embodiment the composition is substantially free of soy. In one embodiment the composition is substantially free of soy and of milk, typically animal milk.

In one embodiment the composition has:

a viscosity of from 500 mPa·s to 4000 mPa·s, preferably from 500 to 1500 mPa·s, preferably from 700 to 1300 mPa·s, and/or

a gel parameter of lower than or equal to 50 g, preferably lower than or equal to 45, preferably of lower than or equal to 35 g, and preferably of higher than 10 g, preferably of higher than 15 g.

The ingredients and the amounts thereof are typically selected to present this viscosity and/or gel parameter.

In a preferred embodiment the composition comprises:

a) from 70 to 90% by weight of water, preferably from 70% to 85%,
b) from 7% to 14% by weight of rice concentrate comprising rice flour, preferably from 7% to 13%,
c) from 1% to 3% by weight of cereal flour selected from oat flour, spelt flour, barley flour and mixtures thereof, preferably oat flour,
d) from 1% to 4% by weight of pea protein.

It is mentioned that the composition might present an acidity that fits with yogurt acidity. The pH of the composition can be for example of from 4 to 6, preferably of from 4.2 to 4.4, for example 4.3. The acidity can be tuned by adding acid ingredients such as malic acid or citric acid. In another embodiment the acidity is obtained by fermentation of lactic acid bacteria.

It is mentioned that in another embodiment the composition might present a neutral acidity. The pH of the composition can be for example of from 6 to 8, preferably of from 6.8 to 7.5, for example 7.3.

### Water

The amount of water in the composition is of at least 50% by weight, preferably of at least 60%, preferably of at least 70%. The amount of water is preferably of less than 90%, preferably of less than 85%. The amount of water is preferably of from 70% to 85% by weight.

The water present in the composition can come from a substantially pure water source, such as tap water. It is mentioned that a part of the water in the composition can come from the further ingredients used to prepare the composition, for example from a fruit preparation. It is mentioned that a part of the water in the composition can come from steam injection, if such a process is used. Such a part of the water is typically a minor part, representing for example at most 10% by weight, preferably at most 5% of the total water comprised in the composition.

As a water source one can typically use tap water, optionally with added calcium to control its hardness. For example one can use tap water having a calcium content of at least 150 mg/L, preferably at least 200 mg/L.

### Rice Concentrate

The composition comprises a rice concentrate comprising rice flour. The rice concentrate can be a mixture of several rice extracts, such as rice flour, rice starch, typically native and/or modified rice starch, rice syrup and optionally rice oil. It is mentioned that the rice concentrate can comprise a rice protein component. These ingredients or extracts or components are known by the one skilled in the art.

The rice concentrate typically comprises at least 75% by weight of rice extract.

It might comprise some moisture (water), for example up to 20% by weight. The rice concentrate typically comprises rice flour, rice syrup, optionally rice starch, and optionally rice oil.

It is possible to use rice concentrates that are commercially available. It is possible to use mixtures or associations of several rice components, such as a complex rice concentrate component and associated to a further rice flour. These can have various forms, such as pastes or powders. These components can be introduced separately in the composition.

A complex rice concentrate component is for example a mixture of rice flour, rice starch, rice syrup and rice oil, for example in a paste form. Such component can comprise for example 5-20% by weight of rice oil, 60-80% of rice syrup, 0.5-10% of rice starch, and 0.5-10% of rice flour. Some additives like stabilizers and/or calcium sources can be present, in an amount of typically up to 10% by weight, preferably up to 5% by weight. As a complex rice concentrate component, one can for example use product Nutriz-M marketed by Beneo.

Further rice flour is typically in the form of a powder. Rice flours are commercially available. One example is Remyflo S200 marketed by Beneo.

If associations or mixtures of a complex rice concentrate component and of a rice flour component are used, the ratio by weight between the complex rice concentrate component and the rice flour component can be for example of 50/50 to 90/10, preferably of from 65/35 to 85/15. As rice concentrate one can for example use an association of Nutriz-M marketed by Beneo and Remyflo S200 marketed by Beneo.

In the rice concentrate, rice flour can typically represent from 0.5% to 75% by weight, preferably from 2% to 50%, preferably from 20% to 40%. If rice syrup is present in the rice concentrate, it can typically represent from 40% to 90% by weight, preferably from 45% to 75%. If rice oil is present in the rice concentrate, it can typically represent from 2% to 20% by weight, preferably from 5% to 15% by weight. If rice starch is present in the rice concentrate, it can typically represent from 1% to 10% by weight, preferably form 2% to 7.5% by weight.

### Cereal Flour

The composition comprises cereal flour, preferably a native or physically pretreated cereal flour, selected from the group consisting of oat flour, spelt flour, barley flour and mixtures thereof. Such cereal flours are known by the one skilled in the art and are commercially available.

The amount of cereal flour is preferably of at least 0.5% by weight. The amount of cereal flour is preferably of at most 5% by weight. The amount of cereal flour is preferably of from 1% to 3% by weight.

Appropriate oat flours are for example oat flour HK marketed by Rubinmüle, or oat flour marketed by Primavera.

### Rice and Cereal Flours

In the composition the relative amount by weight of rice flour compared to the total amount of rice flour and cereal flour is of from 5% to 95%, preferably from 7% to 93%, preferably from 25% to 75%. In other words the weight ratio:

(amount of rice flour)/(amount of rice flour+amount of cereal flour)

is of from 5% to 95%, preferably from 7% to 93%, preferably from 25% to 75%

It is mentioned that the total amount of cereal flour and rice flour is preferably of at least 4% by weight, preferably at least 6% by weight. The amount is preferably of less than 15% by weight, preferably less than 10%.

### Vegetal Protein Source

The vegetal protein source is provided by an ingredient further to the rice concentrate and the cereal flour. The vegetal protein source is different from a protein that might be comprised in the cereal flour, especially oat protein, spelt protein, barley protein, and from rice protein. This source is a further source of proteins. Vegetal protein sources are known by the one skilled in the art. The vegetal protein source can be selected from any vegetal protein source. Examples of vegetal protein sources include pea protein, wheat protein, lupine protein, peanut protein, sesame protein and mixtures thereof.

The vegetal protein source is preferably different from soy protein. Preferred vegetal protein sources include pea protein, wheat protein, lupine protein, peanut protein.

In one preferred embodiment the vegetal protein source is pea protein. This protein source surprisingly provides a particularly good taste impact (including absence of taste) and/or a particularly good color impact (including absence of color) and/or nutritional impact.

### Calcium Source

The composition can comprise a calcium source. Such an ingredient is known by the one skilled in the art and allows improving the calcium content of the composition. The calcium source can be introduced in the composition via other ingredients if some calcium is present in these ingredients, or separately. Introduction of calcium in food products is known by the one skilled in art.

Examples of suitable calcium sources include calcium citrate, calcium phosphate, and calcium sources of vegetal origin.

The amount of calcium in the composition can be for example of from 15% to 60% of the Recommended Daily Acceptance (RDA), and/or of from 50 mg to 400 mg, per 100 g of composition.

### Organoleptic Modifiers

The composition can comprise some organoleptic modifiers, such as sugars or sweeteners, flavors, fruit preparation, nuts or nuts extracts etc. . . . . Such ingredients and preparations are known by the one skilled in the art. They are typically selected to meet the consumers' tastes, with different varieties of products.

Examples of varieties include:

plain, plain with almond,

plain with sugars and/or sweeteners,

fruits,

chocolate,

nuts such as hazelnuts, chesnuts, almonds, or

mix chocolate/nuts.

### Thickening Agent

Thickening agents are known by the one skilled in the art. The thickening agent is an agent further to the rice flour of the rice ingredient and to the cereal flour. The thickening agent is different from rice flour and from cereal flour. The thickening agent can be selected from any thickening agents. Examples of suitable thickening agents include carrageenans, pectins, locust bean gums, arabicum gums, thickening starches, xanthan gums, guar gums and mixtures thereof. Preferred ones are typically carrageenans, starches, pectins and xanthan gums. Starches used as thickening agents are purified starches, and may be present further to starches of rice flour and cereal flour present with other compounds in said flour. The starch can be for example a native starch or a thinned starch or a stabilized starch. Such agents allow to retain stability when submitted to high shear and to avoid gel textures after processing and/or storage. In one preferred embodiment the thickening agent is a carrageenan. The amount of thickening agent can depend on its chemical composition and on the desired viscosity. The amount can be typically of from 0.05% to 5% by weight.

### Further Ingredients

The composition can comprise further ingredients, for example ingredients and additives that are usually used in yogurts, ice-creams, or desserts. These include for example:

fibers,

bacteria, such as ferments comprising lactic acid bacteria and/or probiotics,

pH modifiers,

minerals,

vitamins,

fat or fat substitutes, for example vegetal fat, and

preservatives.

In a preferred embodiment the composition is not a fermented composition comprising lactic acid bacteria.

### Process

The composition can be prepared by any appropriate process. Such processes typically comprise the step of mixing the ingredients. The mixing can be performed in various orders, optionally leading to some premixes, with various means.

An especially appropriate process for making the composition comprises the steps of:

A) mixing and optionally pre-heating at least:
water,
rice concentrate b),
cereal flour c), preferably oat flour,
vegetal protein source d), and
thickening agent g), and
   B) subjecting the mixture of step A) to shear by a direct or indirect heat treatment at a temperature of higher than 100° C., preferably by direct steam injection,
   C) cooling the product of step B), preferably by a flash cooling,
   D) subjecting the product of step C) to a further cooling to storage temperature.

It is mentioned that the ingredients (different from the water) mixed with water during step A) are preferably the dry and/or pasty ingredients.

It is mentioned that the calcium source, some organoleptic modifiers and some further ingredients, if present in the composition, can be mixed and pre-heated during Step A). It is mentioned that some organoleptic modifiers, such as fruit preparations or chocolate, can be added after step C) and/or after step D).

The process can comprise a homogenization step. Such a step can be performed before step B), for example during step A), or between step B) and step D). Such operations are well known by the one skilled in the art.

Step A) can be performed with using conventional equipments such as mixing equipments, heat exchangers, and optionally homogenizers. Step A) can be carried out so that one obtains a mixture at a temperature of at least 60° C., preferably at least 90° C., preferably at a pressure of at least 1.5 bars, preferably at least 2 bars, preferably at least 3 bars. The temperature is typically of below 100° C.

In one embodiment step A) comprises the steps of:

A1) mixing ingredients with water, preferably the dry and/or pasty ingredients,
A2) optionally heating,
A3) optionally homogenizing, and
A4) heating to a temperature of at least 60° C., preferably at least 90° C., typically below 100° C.

It believed that step A) of mixing and pre-heating heating is well adapted to the ingredient mix of b), c) and d) and to the following heat treatment at a temperature of higher than 100° C. It is preferred that the viscosity be as low as possible to avoid pressure problems on the line and to avoid burnings.

Step B) is typically a Ultra High Temperature (UHT) or High Temperature heat treatment. Such treatments are known by the one skilled in the art. Shear is typically created by rapid circulation of the mixture obtained in step A) in an appropriate tubular equipment. The treatment time of step B) can be for example 1 to 30 seconds.

In one embodiment step B) is performed by direct steam injection. Such operations are known by the one in the art. These allow an injection of steam under pressure in a mixture. Steam injection equipments are commercially available. The steam can be for example injected at a temperature of from 130° C. to 150° C. The pressure of the steam depends on the temperature and is preferably of between 3 and 10 bars, preferably between 4 and 7 bars. The treatment time can be for example of from 1 to 10 s.

In a preferred embodiment the steam injection leads to a product at a temperature of at least 130° C. It is believed that viscosity elevation normally due to structuration and/or to swelling of the thickening agent and flours and/or due to network formation of proteins, for example between starch thickening agent and flours, is prevented or destroyed by the treatment of step B), preferably by direct steam injection. This is believed to contribute in providing a smooth texture.

The cooling step C) typically allows the temperature to decrease below 100° C. In a preferred embodiment step C) is performed by flash cooling. Flash cooling operations are known by the one skilled in the art. In a preferred embodiment flash cooling is performed by using a vacuum allowing a temperature drop of at least 40° C., and leads to a product at a temperature of less than 100° C. Flash cooling can allow some extraction of some added water from the product, for example of steam water. Flash cooling can be for example performed in a time of from 0.5 s to 10 s, for example about 1 to 2 s. It is mentioned that flash cooling can contribute to providing some further shear allowing a smoother texture. It is believed that flash cooling can also allow removal of the water from steam injection and lead to better texture and taste.

It is believed that the combination of step B) and step C), together with the association of rice flour and cereal flour can contribute to a good development of the viscosity while avoiding gel and/or sticky textures during processing and/or upon storage.

The further cooling in step D) preferably leads to a product at a temperature of less than 25° C., preferably from 0° C. to 10° C., preferably of from 8° C. to 10° C.

Of course the process will typically comprise a step of filling the composition in a container, such as a cup, and then sealing, to obtain a finished product. The container can be for example a container of from 50 ml to 50 g, to 1 L or 1 kg, for example a 80 ml or 80 g container, or a 100 mL or 100 g container, or a 125 ml or 125 g container, or a 150 mL or 150 g container, or a 200 ml or 200 g container, or a 250 ml or 250 g container, or a 500 ml or 500 g container, or a 750 ml or 750 g container.

The product can be stored, transported and distributed at a chilled temperature of from 0° C. to 10° C., preferably of from 8° C. to 10° C.

### Use of the Composition

The composition is typically to be used as a food product. It is typically used by oral administration. One can use typically a spoon to process the composition from a container to the mouth. The composition provides a good sensory impression, close to a yogurt, both on the spoon and in the mouth. The composition provides a good and/or balanced nutrition.

The composition can be used for preventing lactose intolerance and/or allergies, and/or for preventing milk proteins intolerance and/or allergies.

Further details or advantage to the invention might appear in the following non limitative examples.

### EXAMPLES

Some compositions are prepared, using the procedure(s) described below, with the ingredients mentioned below. Unless otherwise provided the amounts are given as weight %, of ingredients “as is” (as opposed to amounts of ingredients as dry matter).
Nutriz M is a rice concentrate marketed by Beneo, comprising 2-5% of rice flour, 10-15% of rice oil, 65-75% of rice syrup, 2-8% of rice starch, 2.24% of calcium phosphate and 0.5% of carrageenan,
Remyflo S200 is a rice flour marketed by Beneo,
Nutralis S85F is pea protein marketed by Roquette,
C*Gel 099423 is a native starch marketed by Cargill,
Satiagel ADF 155 is a carrageenan marketed by Cargill,
Oat flour HK is an oat flour marketed by Rubinmühle,
Tri-calcium-phosphate is a calcium source marketed by Budenheim,
Almond base 8106 is an almond paste marketed by Blue Diamond,
Hazelnut puree is a hazelnut paste marketed by J. Hervé,
Cocoa D-11-RB is a cocoa powder marketed by ADM,
Chocolate 100067 is a vegetal chocolate marketed by Barry Callebaut,
Fruit preparation: water-based fruit preparation.

Table I below reports the composition, the nutritional profile, and the flours compositions (rice and oat flours amounts, considering an average amount of rice flour in Nutriz M of 2.5%).

TABLE I

| | | | Example 2: | | Example 4 | Example 5 |
|---|---|---|---|---|---|---|
| | | Example 1: | Plain with almond | Example 3 | Comparative | Comparative |
| Type | Ingredient | Fruit Formula | formula | Dessert | (rice alone) | (cereal alone) |
| Water | Water | 82.25% | 82.35% | 72.7% | 82.35% | 82.35% |
| Rice concentrate | Nutriz M | 8.0% | 8.0% | 7.0% | 8.0% | 8.0% |
| | Remyflo S200 | / | 4.0% | 4.0% | 6.0% | / |
| Cereal Flour | Oat flour HK | 2.0% | 2.0% | 2.0% | / | 6.0% |
| Protein Source | Pea Protein | 1.9% | 1.2% | 0.9% | 1.2% | 1.2% |
| Calcium source | Tri-calcium phosphate | 0.1% | 0.1% | 0.1% | 0.1% | 0.1% |
| organoleptic | Flavors | Minor | Minor | Minor | Minor | Minor |
| modifiers* | Nuts preparation | / | 2.0% almond paste | 2.0% hazelnut paste | 2.0% almond paste | 2.0% almond |
| | | | | | | paste |
| | Cocoa | / | / | 2.0% | / | / |
| | Sugar | 3.0% | / | 9.0% | / | / |
| Thickening agent | Starch C*Gel 099423 | 2.4% | / | / | / | / |
| | Carrageenan Satiagel ADF | 0.35% | 0.35% | 0.30% | 0.35% | 0.35% |
| | 155 | | | | | |
| | TOTAL “White mass” | 100% | 100% | 100% | 100% | 100% |
| organoleptic | Fruit preparation | 15.5 part | / | / | / | / |
| modifiers** | Chocolate | / | / | 2.0 part | / | / |
| TOTAL | Nutritional profile (for 100 g) | | | | | |
| | Dry Matter | 15 g | 15 g | 15 g | 15 g | 15 g |
| | Protein | 2.0 g | 2.0 g | 2.0 g | 1.9 g | 2.3 g |
| | Fat | 1.3 g | 2.5 g | 2.1 g | 2.4 g | 2.7 g |
| | Carbohydrate | 11.5 g | 10.0 g | 19.0 g | 10.3 g | 9.2 g |
| | pH | 4.3 | 7.3 | 7.1 | 7.5 | 7.2 |
| | Flours composition | | | | | |
| | Rice flour | 0.28% | 4.28% | 4.28% | 6.28% | 0.28% |
| | Oat flour | 2.0% | 2.0% | 2.0% | 0% | 2.0% |
| | Rice flour/(Rice flour + Oat | 12.28% | 68.15% | 68.15% | 100% | 4.46% |
| | flour) | | | | | |

*added in “white mass” (as % of white mass)
**added after cooling (as parts by weight per 100 parts of “white mass”)

### Procedure

A “white mass” composition is prepared by the following procedure:
mixing and pre-heating to a temperature of 90° C.,
subjecting to steam injection at a temperature of 140° C. during 4 s with an equipment supplied by APV (coupled with the flash cooler),
homogenization at a pressure of 100 bars (350 bars for Example 3), and
flash cooling to a temperature of 10° C. with an equipment supplied by APV (coupled with a direct steam injector).

In examples 2, 4, 5, the white mass is the finished composition.

In examples 1 and 3, a fruit preparation or chocolate are misted after cooling to provide the finished composition.

### Evaluations

The compositions are subjected the various evaluations described and reported in table II below.
Viscosity: Measured with Rheomat apparatus, T=10° C., tube 2, bob 2, one point of measurement, t=10 s, shear rate 64 s⁻¹)
Gel parameter: Measured with TAXT-2 apparatus, T=10° C., cylinder 25 mm, distance of penetration=20 mm, speed of plunger=0.2 mm/s, value of preload=0.5 g. The lower the gel parameter is, the better the composition is.
Evaluation of stickiness on spoon and in mouth (sensory):
   on spoon: Stickiness and/or adherence to spoon surface. Low stickiness and/or adherence is desired.
   in mouth: taking product in the mouth, pressing the tongue to the palate and trying to go back with the tongue. If the composition is easy to dissolve it is considered as not sticky; if the composition is hard to dissolve it is considered as sticky.
Vegetal taste: Evaluation of taste of vegetal origin (e.g. rice, oat, beany) tasting the composition in mouth. Neutral or slight tastes are desired.
Off-taste: Evaluation of off-tastes like bitter, paper, by tasking the composition in mouth. No of slight off-tastes are desired.
Appearance/aspect: Visual observation: transparency, opacity, shiny.

TABLE II
Results

| | | Example 2: | | | |
|---|---|---|---|---|---|
| | Example 1: | Plain with | | | |
| | Fruit | almond | Example 3 | Example 4 | Example 5 |
| Evaluation | Formula | formula | Dessert | Comparative | Comparative |
| Viscosity (mPa · s) | 800 +− 100 | 800 +− 100 | 1200 +− 100 | 500 +− 100 | 900 +− 100 |
| Gel parameter (g) | 20.0-30.0 | 20.0-25.0 | 35.0-45.0 | 18.0-22.0 | 20.0-25.0 |
| | | | | Gel formation | |
| | | | | during shelf- | |
| | | | | life | |
| Stickiness | not sticky | not sticky | slightly | sticky | sticky |
| | | | sticky | | |
| | | | like dessert | | |
| vegetal taste | neutral | slight rice + | cocoa, | Rice | strong oat, |
| | | oat | chocolate + | | cereal |
| | | | slight beany | | |
| off-taste | no | no | no | Paper | bitter |
| appearance/aspect | beige, | beige, | dark brown, | white, shiny, | beige/grey |
| | creamy, | creamy, | creamy, | transparent, | with many |
| | shiny | shiny | shiny | watery | spots, shiny, |
| | | | | | creamy |

These examples show that an association of rice flour and cereal flour in an appropriate ratio according to the invention allows a limitation of stickiness, with a good taste.

1. A composition comprising:
a) at least 50% by weight of water,
b) at least one rice concentrate comprising rice flour,
c) a cereal flour selected from the group consisting of oat flour, spelt flour, barley flour and mixtures thereof,
d) at least one vegetal protein source, further to the rice concentrate and the cereal flour,
e) optionally a calcium source,
f) optionally organoleptic modifiers,
g) a thickening agent, further to the rice flour and the cereal flour,
wherein the relative amount by weight of rice flour compared to the total amount of rice flour and cereal flour is of from 5% to 95%, and the total amount of rice flour and cereal flour is of at least 4% by weight, and
wherein the composition has, per 100 g of composition:
a protein content of at least 1 g,
a fat content of from 0.1 g to 10 g,
a carbohydrate content of from 5 g to 45 g.

2. A composition according to claim 1, wherein the rice concentrate comprises rice flour, rice syrup, optionally rice starch, and optionally rice oil.

3. A composition according to claim 1, wherein the vegetal protein source is selected from the group consisting of pea protein, wheat protein, lupine protein, peanut protein, sesame protein, rice protein and mixtures thereof.

4. A composition according to claim 1, wherein the thickening agent is selected from the group consisting of carrageenans, pectins, locust bean gums, arabicum gums, thickening starches, xanthan gums, guar gums and mixtures thereof.

5. A composition according to claim 1, wherein the composition is substantially free of animal milk, or substantially free of soy, or substantially free of animal milk and of soy.

6. A composition according to claim 1, comprising:
a) from 70 to 90% by weight of water,
b) from 7 to 14% by weight of rice concentrate comprising rice flour,
c) from 1 to 3% by weight of a cereal flour selected from oat flour, spelt flour, barley flour and mixtures thereof, preferably oat flour, and
d) from 1 to 4% by weight of pea protein.

7. A composition according to claim 1, wherein the composition has:
a viscosity of from 500 mPa·s to 4000 mPa·s, and/or
a gel parameter of lower than or equal to 50 g.

8. A process for making the composition according to any of the preceding claims, comprising the steps of:
A) mixing and optionally pre-heating at least:
water,
rice concentrate b),
cereal flour c), preferably oat flour,
vegetal protein source d), and
thickening agent g), and
B) subjecting the mixture of step A) to shear by a direct or indirect heat treatment at a temperature of higher than 100 ′O,
C) cooling the product of step B), and
D) subjecting the product of step C) to a further cooling to storage temperature.

9. A process according to claim 8, wherein step B) is performed by direct steam injection.

10. A process according to claim 8, wherein step A) leads to a mixture at a temperature of at least 60° C., preferably of at least 90 ′O.

11. A process according to claim 8, comprising a homogenization step.

12. A process according to claim 8, wherein step A) comprises the steps of A1) mixing the ingredients with water,
A2) optionally heating,
A3) optionally homogenizing, and
A4) heating to a temperature of at least 60° C., preferably at least 90° C.

13. A process according to claim 8, wherein step B) is performed by direct steam injection and leads to a product at a temperature of at least 130 ′O.

14. A process according to claim 8, wherein step C) is performed by flash cooling, using a vacuum allowing a temperature drop of at least 40° C., and leads to a product at a temperature of less than 100° C.

15. A process according to claim 8, wherein step D) leads to a product at a temperature of less than 25° C.

16. Use of the composition according to claim 1 as food by oral administration.
